(19) United States
(12) Patent Application Publication
(10) Pub. No.: US 2010/0146601 A1
(43) Pub. Date: Jun. 10, 2010

(54) Method for Exercising Digital Rights via a Proxy

(75) Inventors: Steve R. Bunch, Harvard, IL (US); James M. Connor, St. Charles, IL (US); Ezzat A. Dabbish, Cary, IL (US); John Richard Kane, Fox River Grove, IL (US); Aroon V. Tungare, Winfield, IL (US)

Correspondence Address: Motorola, Inc.;Law Department, 1303 East Algonquin Road, 3rd Floor, Schaumburg, IL, 60196, US

(73) Assignee: MOTOROLA, INC., Schaumburg, IL (US)

(21) Appl. No.: 12/330,867

(22) Filed: Dec. 9, 2008

(51) Int. Cl. G06F 21/00

(52) U.S. Cl. 726/6; 726/27

(57) ABSTRACT

A system and method for accessing digital content purchased by a rights owner for a first computing device. The method receives a proxy from the rights owner that includes rights to the digital content granted to the rights owner, stores the proxy on a second computing device, and determines whether the rights owner is present at the second computing device. When the rights owner is present at the second computing device, the method enables the proxy, and accesses the digital content on the second computing device through the proxy.

### BACKGROUND

It has become increasingly popular for a consumer to play digital content on personal computers, consumer electronics devices, and mobile devices. The digital content includes digital audio, digital images, digital video, computer software and games, and the like. The consumer purchases a copy of the digital content from a content provider. In exchange, the content provider grants the consumer the right to download the copy to their device, and legally use the copy.

Digital Rights Management (DRM) is an access control technology that allows the content provider who sells the digital content to the consumer to define a set of rules that allow or disallow specific uses of the copy of the digital content by the consumer. The content provider is typically a publisher, artist, copyright holder, or someone who has an ownership interest in the digital content. The rules include the right to preview the digital content, the right to forward the digital content to a third party, the right to full use of the digital content, and the like. The consumer becomes a rights owner of the digital content after purchasing a copy of the digital content from the content provider.

The Open Mobile Alliance (OMA) DRM system is a prior art method for delivering the digital content to the rights owner. The device that the rights owner uses to purchase the digital content includes an individual DRM public key infrastructure (PKI) certificate with a public key, and the corresponding private key. After purchasing the digital content, the rights owner receives a rights object for the digital content. The content provider protects the rights object for the receiving device by encrypting it with the public key for the device. The rights object includes the digital content, in an encrypted form, rights that describe the allowable uses of the digital content, and a key that the rights owner uses to decrypt the encrypted digital content.

When the consumer purchases the digital content, he agrees to use the digital content in a manner consistent with the rights conveyed by the content provider. Those rights may include the right to transfer or forward the digital content to another device. If the digital content was a video stored on a set-top box, digital video recorder, or television in the consumer's family room, the consumer may desire to transfer the digital content to another set-top box, digital video recorder, or television in the consumer's bedroom or at another location, such as a friend's house. If the digital content was digital audio, the consumer may desire to transfer the digital audio to a hotel or car rental agency for an upcoming trip. Transferring the digital content from one device to another device is difficult due to the size of the digital content, the need to establish a secure and dependable connection, and confirmation of a successful transmission. Furthermore, the transfer is likely to result in an extra copy of the digital content that a third party can obtain and use.

Thus, there is a demand for a system and method that will utilize a revocable proxy to allow the digital rights owner to transfer the digital content to another device, exercise the rights conveyed by the content provider on the other device, and revoke the proxy rights at the conclusion of the allowed exercise of rights. The presently disclosed invention satisfies this demand.

### SUMMARY

A system and method for accessing digital content purchased by a rights owner for a first computing device. The method receives a proxy from the rights owner that includes rights to the digital content granted to the rights owner, stores the proxy on a second computing device, and determines whether the rights owner is present at the second computing device. When the rights owner is present at the second computing device, the method enables the proxy, and accesses the digital content on the second computing device through the proxy.

### BRIEF DESCRIPTION OF THE DRAWINGS

FIG. 1 is network diagram that illustrates one embodiment of the hardware components of a system that performs the present invention.

FIG. 2 is a block diagram that illustrates, in detail, one embodiment of the hardware components shown in FIG. 1.

FIG. 3 is a message flow diagram that illustrates a method for accessing digital content purchased by a rights owner for a computing device according to an embodiment of the present invention.

FIG. 4 is a message flow diagram that illustrates a method for accessing digital content purchased by a rights owner for a computing device according to an embodiment of the present invention.

FIG. 5 is a message flow diagram that illustrates a method for accessing digital content purchased by a rights owner for a computing device according to an embodiment of the present invention.

### DETAILED DESCRIPTION

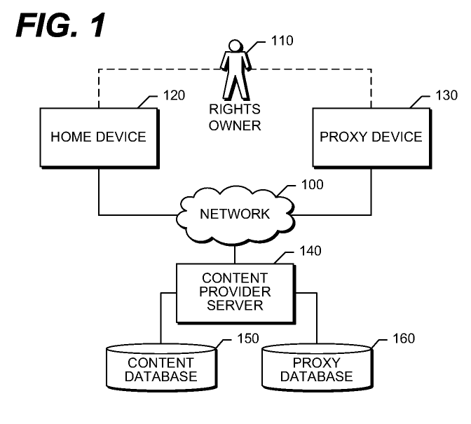

FIG. 1 is network diagram that illustrates one embodiment of the hardware components of a system that performs the present invention. As shown in FIG. 1, a home device 120 connects to a content provider server 140 via a network 100. The home device 120 includes a digital video recorder, set-top box, digital audio or video media player, such as a television, radio, or music player, portable hard drive, or the like. A rights owner 110 operates the home device 120 to purchase digital content from a content provider associated with the content provider server 140, and download the digital content from the content provider server 140 to the home device 120. The content provider includes digital audio or video media providers, subscription or pay-per-view services, hotels, car rental services, or the like. In one embodiment, a direct access storage device that connects to the content provider server 140 stores a content database 150 that includes the digital content. In another embodiment, the connection between the content provider server 140 and the content database 150 is via the network 100.

The home device 120 shown in FIG. 1 also connects to a proxy device 130 via the network 100. After the rights owner 110 purchases the digital content from the content provider, the rights owner 110 may desire to access the digital content from the proxy device 130, rather than from the home device 120. The proxy device 130 includes a digital video recorder, set-top box, digital audio or video media player, such as a television, radio, or music player, portable hard drive, or the like. In one embodiment, the rights owner 110 operates the home device 120 to send a proxy to the proxy device 130, and later performs an explicit act at the location of the proxy device 130 to enable the proxy. In another embodiment, the rights owner 110 operates the home device 120 to send the proxy to the content provider server 140 for storage in the proxy database 160, and later performs an explicit act at the location of the proxy device 130 to retrieve and enable the proxy. In yet another embodiment, the rights owner 110 operates the proxy device 130, or a mobile device at the location of the proxy device 130, to send a request to the home device 120, or the content provider server 140, for a proxy to access the digital content that the rights owner 110 purchased from the content provider.

The proxy device 130 functions as a substitute for the home device 120 for the rights owner 110. The proxy that the proxy device 130 receives may represent or encode the rights object for the proxy device 130. In one embodiment, the content provider server 140 encodes the proxy rights so that the proxy is only valid on the proxy device 130. The proxy may include the rights granted to the rights owner 110 by the content provider, or any subset of those rights. For example, if the rights owner 110 is a subscriber to a cable or satellite sports package, the proxy may include the rights to the entire subscription, or only the rights to the subscription for a specific date. Since the proxy is revocable, the rights owner 110 may specify that the rights are dependent on a revocation condition, such as expiring on a specific date, after a number of accesses, or the like.

The network 100 shown in FIG. 1 is a communication network that connects and enables data transfer between the home device 120, proxy device 130, and content provider server 140. In one embodiment, the network 100 is a public communication network. The present invention also contemplates the user of comparable network architectures. Comparable network architectures include the Public Switched Telephone Network (PSTN), a public packet-switched network carrying data and voice packets, a wireless network, a private network, and the like. A wireless network includes a cellular network (e.g., a Time Division Multiple Access (TDMA) or Code Division Multiple Access (CDMA) network), a satellite network, a wireless Local Area Network (LAN) (e.g., a wireless fidelity (Wi-Fi) network), and the like. A private network includes a LAN, a Personal Area Network (PAN) such as a Bluetooth network, a wireless LAN, a Virtual Private Network (VPN), an intranet, an extranet, and the like. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organizations network. The system also contemplates network architectures and protocols such as Ethernet, Token Ring, Systems Network Architecture, Internet Protocol, Transmission Control Protocol, User Datagram protocol, Asynchronous Transfer Mode, proprietary network protocols comparable to the Internet Protocol, and the like.

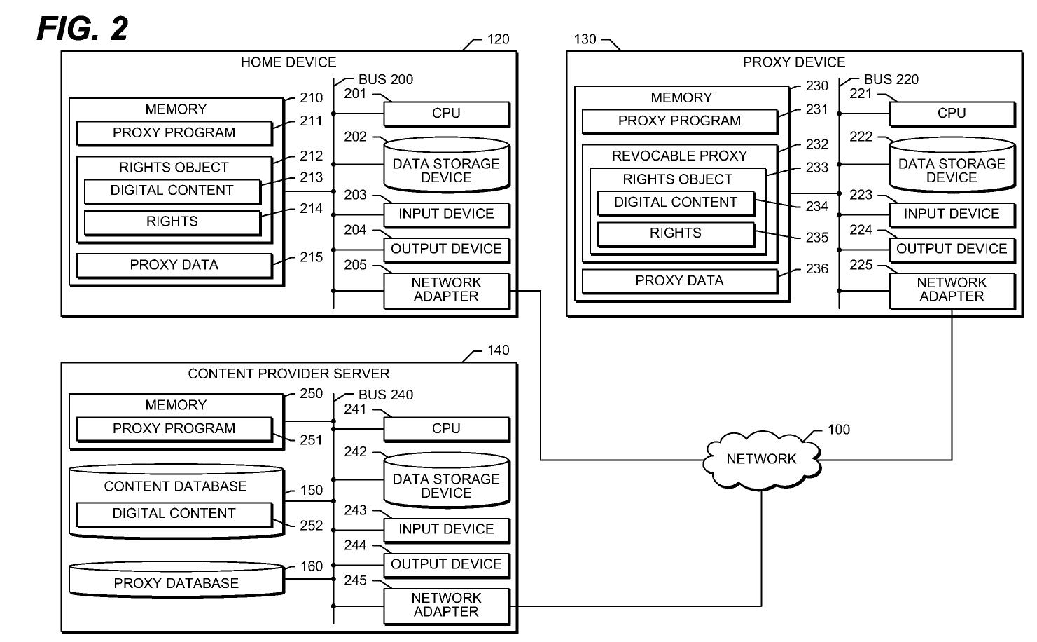

FIG. 2 is a block diagram that illustrates, in detail, one embodiment of the hardware components shown in FIG. 1. In particular, FIG. 2 illustrates the hardware components and software comprising the home device 120, proxy device 130, and content provider server 140.

The home device 120 shown in FIG. 2 is a general-purpose computer that performs the present invention. A bus 200 is a communication medium that connects a central processor unit (CPU) 201, data storage device 202 (such as a disk drive, flash drive, flash memory, or the like), input device 203 (such as a keyboard, keypad, touchscreen, or the like), output device 204 (such as a monitor, graphic display, television screen, or the like), network adapter 205, and memory 210. The network adapter 205 transmits and receives network traffic for the home device 120. In one embodiment, the network adapter 205 connects to the network 100 and is the mechanism that facilitates the passage of network traffic between the home device 120 and the network 100.

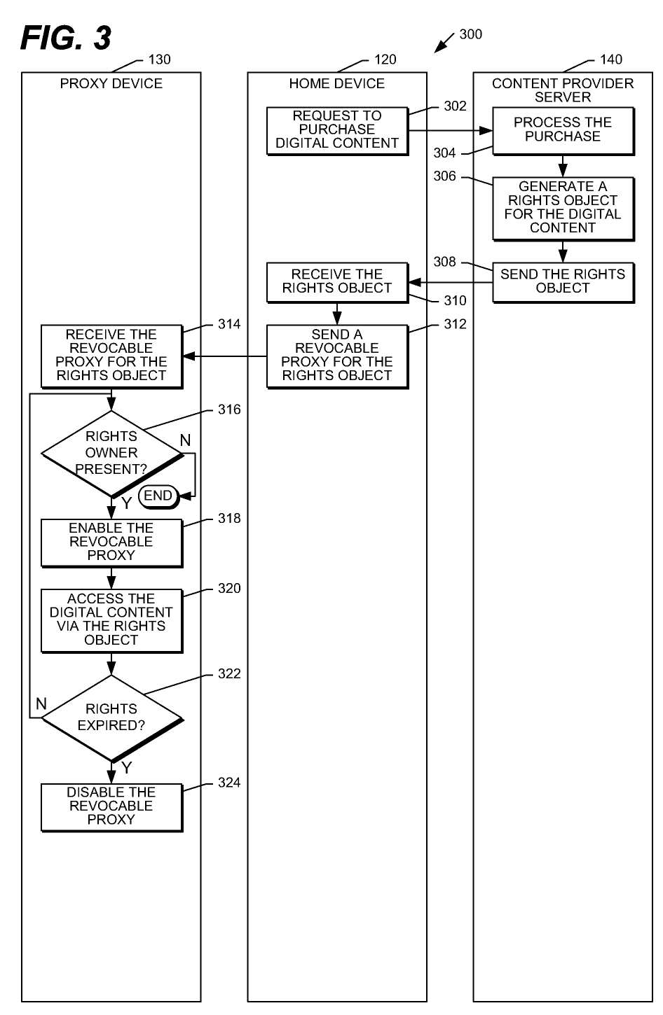

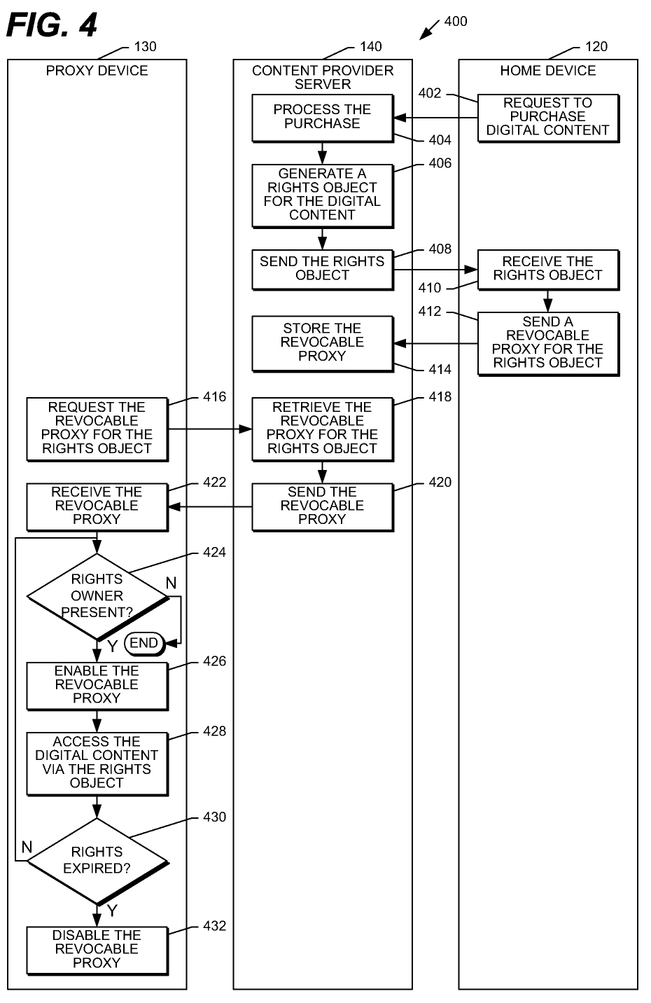

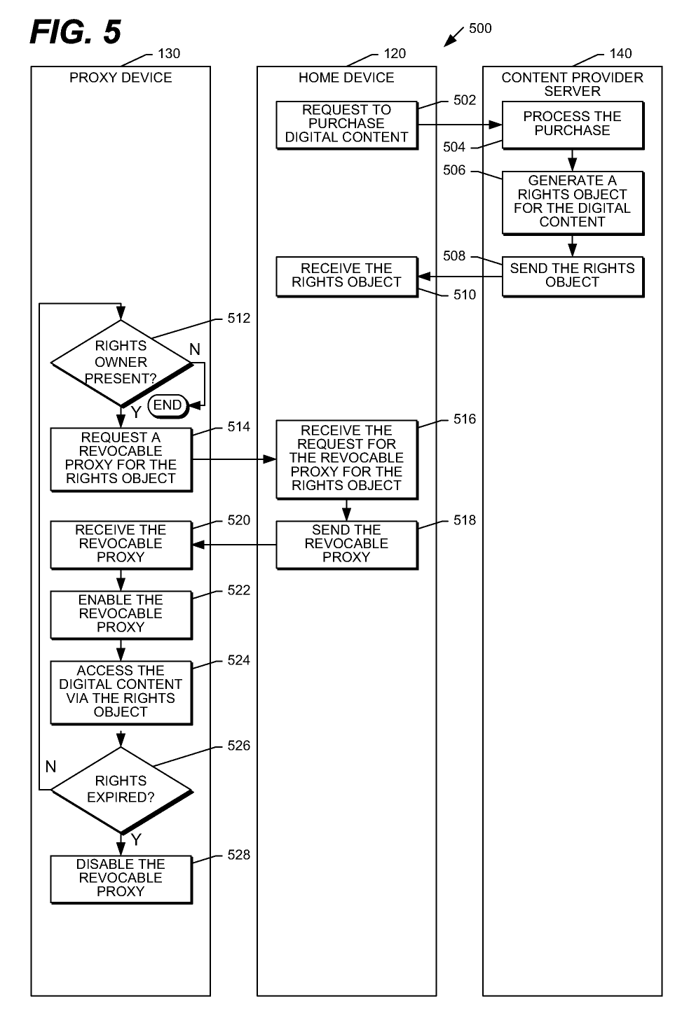

The CPU 201 performs the disclosed methods by executing the sequences of operational instructions that comprise each computer program resident in, or operative on, the memory 210. The reader should understand that the memory 210 may include operating system, administrative, and database programs that support the programs disclosed in this application. In one embodiment, the configuration of the memory 210 of the home device 120 includes a proxy program 211, rights object 212, and proxy data 215. The rights object 212 includes digital content 213, and rights 214. The proxy program 211 and proxy data 215 perform the method of the present invention disclosed in detail in FIG. 3, FIG. 4, and FIG. 5. One skilled in the art will recognize that the rights 214, digital content 213, rights object 212, or proxy data 215, in any combination, may be specially protected within the memory 210, in order to prevent tampering or unauthorized disclosure. These computer programs store intermediate results in the memory 210, or data storage device 202. In another embodiment, the memory 210 may swap these programs, or portions thereof, in and out of the memory 210 as needed, and thus may include fewer than all of these programs at any one time.

The proxy device 130 shown in FIG. 2 is a general-purpose computer that performs the present invention. A bus 220 is a communication medium that connects a central processor unit (CPU) 221, data storage device 222 (such as a disk drive, flash drive, flash memory, or the like), input device 223 (such as a keyboard, keypad, touchscreen, or the like), output device 224 (such as a monitor, graphic display, television set, or the like), network adapter 225, and memory 230. The network adapter 225 transmits and receives network traffic for the proxy device 130. In one embodiment, the network adapter 225 connects to the network 100 and is the mechanism that facilitates the passage of network traffic between the proxy device 130 and the network 100.

The CPU 221 performs the disclosed methods by executing the sequences of operational instructions that comprise each computer program resident in, or operative on, the memory 230. The reader should understand that the memory 230 may include operating system, administrative, and database programs that support the programs disclosed in this application. In one embodiment, the configuration of the memory 230 of the proxy device 140 includes a proxy program 231, revocable proxy 232, and proxy data 236. The revocable proxy 232 includes rights object 233, which includes digital content 234, and rights 235. The proxy program 231 and proxy data 235 perform the method of the present invention disclosed in detail in FIG. 3, FIG. 4, and FIG. 5. One skilled in the art will recognize that the rights 235, digital content 234, rights object 233, or proxy data 236, in any combination, may be specially protected within the memory 230, in order to prevent tampering or unauthorized disclosure. These computer programs store intermediate results in the memory 230, or data storage device 222. In another embodiment, the memory 230 may swap these programs, or portions thereof, in and out of the memory 230 as needed, and thus may include fewer than all of these programs at any one time.

The content provider server 140 shown in FIG. 2 is a general-purpose computer including server functionality, such as file services, web page services, or the like, that performs the present invention. A bus 240 is a communication medium that connects a central processor unit (CPU) 241, data storage device 242 (such as a disk drive, flash drive, flash memory, or the like), input device 243 (such as a keyboard, keypad, touchscreen, or the like), output device 244 (such as a monitor, graphic display, or the like), network adapter 245, memory 250, content database 150, and proxy database 160. The network adapter 245 transmits and receives network traffic for the content provider server 140. In one embodiment, the network adapter 245 connects to the network 100 and is the mechanism that facilitates the passage of network traffic between the content provider server 140 and the network 100. In one embodiment, the content database 150 and proxy database 160 are stored on a direct access storage device, such as the data storage device 242, and connect to the content provider server 140 via the bus 240. In another embodiment, the content database 150 and proxy database 160 are stored separately from the content provider server 140 and are accessible to the content provider server 140 via a communications connection, such as that provided by the network adapter 245.

The CPU 241 performs the disclosed methods by executing the sequences of operational instructions that comprise each computer program resident in, or operative on, the memory 250. The reader should understand that the memory 250 may include operating system, administrative, and database programs that support the programs disclosed in this application. In one embodiment, the configuration of the memory 250 of the content provider server 140 includes a proxy program 251, and the content database 150 includes digital content 252. The proxy program 251 performs the method of the present invention disclosed in detail in FIG. 3, FIG. 4, and FIG. 5. These computer programs store intermediate results in the memory 250, or data storage device 242. In another embodiment, the memory 250 may swap these programs, or portions thereof, in and out of the memory 250 as needed, and thus may include fewer than all of these programs at any one time.

FIG. 3 is a message flow diagram that illustrates a method for accessing digital content purchased by a rights owner for a computing device according to an embodiment of the present invention. In particular, FIG. 3, with reference to FIG. 1 and FIG. 2, illustrates the rights owner 110 operating the home device 120 to send a proxy to the proxy device 130, and later performing an explicit act at the location of the proxy device 130 to enable the proxy.

The process 300 shown in FIG. 3 begins when a user decides to purchase digital content 252 from a content provider. The user operates the home device 120 to send a request to purchase the digital content 252 (step 302) to a content provider server 140. The content provider server 140 receives the request, processes the purchase (step 304), generates a rights object for the digital content (step 306), and sends the rights object to the home device 120 (step 308). The home device 120 receives the rights object (step 310), and stores it in a secure location, such as the memory 210 or data storage device 202. After purchasing the digital content, the user becomes a rights owner 110 of the digital content.

When the rights owner 110 desires to access the digital content from the proxy device 130, rather than from the home device 120, as shown in FIG. 3, the rights owner 110 operates the home device 120 to send a revocable proxy 232 for the rights object 212 to the proxy device 130 (step 312). The proxy device 130 receives the revocable proxy 232 for the rights object 212 (step 314), and stores it in a secure location, such as the memory 230, data storage device 222, or the like.

The proxy device 130 cannot access the revocable proxy 232 when the rights owner 110 is not present (step 316, N branch). To verify that the rights owner 110 is present (step 316, Y branch), the rights owner 110 performs an explicit act, such as presenting a credit card at check-in, providing biometric data, two-factor authentication data, location data using a cell phone, radio-frequency identification tag, or other presence indicating device, or the like. In one embodiment, the proxy device 130 includes a peripheral device for detecting the presence of the rights owner 110. Performing the explicit act has several advantages including preventing fraud, and providing an audit trail. Once the proxy device 130 confirms the presence of the rights owner 110 (step 316, Y branch), the proxy device 130 enables the revocable proxy 232 (step 318), and grants access to the digital content 234 via the rights object 233 (step 320). If the rights have expired (step 322, Y branch) after accessing the digital content 234, the proxy device 130 disables, or deletes, the revocable proxy 232 (step 324). If the rights have not expired (step 322, N branch), the proxy device 130 may access the digital content 234 as long as the rights owner 110 is present at the proxy device 130.

FIG. 4 is a message flow diagram that illustrates a method for accessing digital content purchased by a rights owner for a computing device according to an embodiment of the present invention. In particular, FIG. 4, with reference to FIG. 1 and FIG. 2, illustrates the rights owner 110 operating the home device 120 to send a proxy to the content provider server 140 for storage in the proxy database 160, and later performing an explicit act at the location of the proxy device 130 to retrieve and enable the proxy.

The process 400 shown in FIG. 4 begins when a user decides to purchase digital content 252 from a content provider. The user operates the home device 120 to send a request to purchase the digital content 252 (step 402) to a content provider server 140. The content provider server 140 receives the request, processes the purchase (step 404), generates a rights object for the digital content (step 406), and sends the rights object to the home device 120 (step 408). The home device 120 receives the rights object (step 410), and stores it in a secure location, such as the memory 210 or data storage device 202. After purchasing the digital content, the user becomes a rights owner 110 of the digital content.

When the rights owner 110 desires to access the digital content from the proxy device 130, rather than from the home device 120, as shown in FIG. 4, the rights owner 110 operates the home device 120 to send a revocable proxy 232 for the rights object 212 to the content provider server 140 (step 412). The content provider server 140 receives the revocable proxy 232 and stores it (step 414) in a secure location, such as proxy database 160, memory 250, data storage device 242, or the like. At a later time, the proxy device 130 sends a request for the revocable proxy 232 for the rights object 212 to the content provider server 140 (step 416). The content provider server 140 receives the request, retrieves the revocable proxy 232 (step 418), and sends the revocable proxy 232 to the proxy device 130 (step 420). The proxy device 130 receives the revocable proxy 232 for the rights object 212 (step 422), and stores it in a secure location, such as the memory 230, data storage device 222, or the like.

The proxy device 130 cannot access the revocable proxy 232 when the rights owner 110 is not present (step 424, N branch). To verify that the rights owner 110 is present (step 424, Y branch), the rights owner 110 performs an explicit act, such as presenting a credit card at check-in, providing biometric data, two-factor authentication data, location data using a cell phone, radio-frequency identification tag, or other presence indicating device, or the like. Performing the explicit act has several advantages including preventing fraud, and providing an audit trail. Once the proxy device 130 confirms the presence of the rights owner 110 (step 424, Y branch), the proxy device 130 enables the revocable proxy 232 (step 426), and grants access to the digital content 234 via the rights object 233 (step 428). If the rights have expired (step 430, Y branch) after accessing the digital content 234, the proxy device 130 disables, or deletes, the revocable proxy 232 (step 432). If the rights have not expired (step 430, N branch), the proxy device 130 may access the digital content 234 as long as the rights owner 110 is present at the proxy device 130.

FIG. 5 is a message flow diagram that illustrates a method for accessing digital content purchased by a rights owner for a computing device according to an embodiment of the present invention. In particular, FIG. 5, with reference to FIG. 1 and FIG. 2, illustrates the rights owner 110 operating the proxy device 130 to send a request to the home device 120 for a proxy to access the digital content that the rights owner 110 purchased from the content provider.

The process 500 shown in FIG. 5 begins when a user decides to purchase digital content 252 from a content provider. The user operates the home device 120 to send a request to purchase the digital content 252 (step 502) to a content provider server 140. The content provider server 140 receives the request, processes the purchase (step 504), generates a rights object for the digital content (step 506), and sends the rights object to the home device 120 (step 508). The home device 120 receives the rights object (step 510), and stores it in a secure location, such as the memory 210 or data storage device 202. After purchasing the digital content, the user becomes a rights owner 110 of the digital content.

When the rights owner 110 desires to access the digital content from the proxy device 130, rather than from the home device 120, as shown in FIG. 5, the rights owner 110 is present at the proxy device 130. The rights owner 110 operates the proxy device 130 to retrieve a revocable proxy 232 for the rights object 212. In another embodiment, the rights owner 110 operates another device, such as a mobile device, at the location of the proxy device 130 to retrieve the revocable proxy 232 for the rights object 212.

The proxy device 130 cannot retrieve the revocable proxy 232 when the rights owner 110 is not present (step 512, N branch). To verify that the rights owner 110 is present (step 512, Y branch), the rights owner 110 performs an explicit act, such as presenting a credit card at check-in, providing biometric data, two-factor authentication data, location data using a cell phone, radio-frequency identification tag, or other presence indicating device, or the like. Performing the explicit act has several advantages including preventing fraud, and providing an audit trail. Once the proxy device 130 confirms the presence of the rights owner 110 (step 512, Y branch), the proxy device 130 sends a request for a revocable proxy 232 for the rights object 212 to the home device 120 (step 514). In another embodiment, the proxy device 130 sends the request to the content provider server 140. As shown in FIG. 5, the home device 120 receives the request for the revocable proxy 232 (step 516), and sends the revocable proxy 232 to the proxy device 130 (step 518). The proxy device 130 receives and stores the revocable proxy 232 (step 520), enables the revocable proxy 232 (step 522), and grants access to the digital content 234 via the rights object 233 (step 524). If the rights have expired (step 526, Y branch) after accessing the digital content 233, the proxy device 130 disables, or deletes, the revocable proxy 232 (step 526). If the rights have not expired (step 526, N branch), the proxy device 130 may access the digital content 234 as long as the rights owner 110 is present at the proxy device 130.

Although the disclosed embodiments describe a fully functioning system and method for accessing digital content purchased by a rights owner for a computing device, the reader should understand that other equivalent embodiments exist. Since numerous modifications and variations will occur to those reviewing this disclosure, the system and method for accessing digital content purchased by a rights owner for a computing device is not limited to the exact construction and operation illustrated and disclosed. Accordingly, this disclosure intends all suitable modifications and equivalents to fall within the scope of the claims.

We claim:

1. A method for accessing digital content purchased by a rights owner for a first computing device, comprising:
receiving a proxy from the rights owner, the proxy including rights to the digital content granted to the rights owner;
storing the proxy on a second computing device;
determining whether the rights owner is present at the second computing device; and
when the rights owner is present at the second computing device:
enabling the proxy; and
accessing the digital content on the second computing device through the proxy.

2. The method of claim 1, wherein the receiving of the proxy is from the first computing device.

3. The method of claim 1, wherein the receiving of the proxy is from a content provider server, and wherein the rights owner purchased the digital content from the content provider server.

4. The method of claim 1, wherein the receiving of the proxy further comprises:
sending a request for the proxy.

5. The method of claim 1, wherein the determining of whether the rights owner is present at the second computing device further comprises:
obtaining identification information from the rights owner;
determining a location of the rights owner based on the identification information; and
comparing the location of the rights owner to a location of the second computing device.

6. The method of claim 5, wherein the identification information includes at least one of biometric data, authentication data, or location data.

7. The method of claim 1, wherein the proxy further includes a revocation condition, and wherein when the revocation condition is met, the method further comprises:
disabling the proxy.

8. A system for accessing digital content purchased by a rights owner for a first computing device, comprising:
a memory device resident in the computing device; and
a processor disposed in communication with the memory device, the processor configured to:
receive a proxy from the rights owner, the proxy including rights to the digital content granted to the rights owner;
store the proxy on a second computing device;
determine whether the rights owner is present at the second computing device; and
when the rights owner is present at the second computing device:
enable the proxy; and
access the digital content on the second computing device through the proxy.

9. The system of claim 8, wherein to receive the proxy, the processor is further configured to:
send a request for the proxy.

10. The system of claim 8, wherein to determine whether the rights owner is present at the second computing device, the processor is further configured to:
obtain identification information from the rights owner;
determine a location of the rights owner based on the identification information; and
compare the location of the rights owner to a location of the second computing device.

11. The system of claim 10, wherein the identification information includes at least one of biometric data, authentication data, or location data.

12. The system of claim 8, wherein the proxy further includes a revocation condition, and wherein when the revocation condition is met, the processor is further configured to:
disable the proxy.

13. A method for accessing digital content purchased by a rights owner for a first computing device, comprising:
sending a proxy to a second computing device, the proxy including rights to the digital content granted to the rights owner;
performing an explicit act to demonstrate that the rights owner is present at the second computing device; and
accessing the digital content on the second computing device through the proxy.

14. The method of claim 13, further comprising:
receiving a request for the proxy; and
retrieving the proxy.

15. The method of claim 13, wherein the explicit act includes at least one of providing biometric data, authentication data, or location data.

16. The method of claim 13, wherein the proxy further includes a revocation condition, and wherein when the revocation condition is met, the method further comprises:
disabling the proxy.

17. A system for accessing digital content purchased by a rights owner for a first computing device, comprising:
a memory device resident in said at least one computing device; and
a processor disposed in communication with the memory device, the processor configured to:
send a proxy to a second computing device, the proxy including rights to the digital content granted to the rights owner;
perform an explicit act to demonstrate that the rights owner is present at the second computing device; and
access the digital content on the second computing device through the proxy.

18. The system of claim 17, wherein the processor is further configured to:
receive a request for the proxy; and
retrieve the proxy.

19. The system of claim 17, wherein the explicit act includes at least one of providing biometric data, authentication data, or location data.

20. The system of claim 17, wherein the proxy further includes a revocation condition, and wherein when the revocation condition is met, the processor is further configured to:
disable the proxy.
